(19) United States
(12) Patent Application Publication
(10) Pub. No.: US 2003/0037312 A1
(43) Pub. Date: Feb. 20, 2003

(54) Documentation generator

(76) Inventor: Gerald Czech, Hartkirchen (AT)

Correspondence Address: DAVIDSON, DAVIDSON & KAPPEL, LLC, 485 SEVENTH AVENUE, 14TH FLOOR, NEW YORK, NY, 10018, US

(21) Appl. No.: 09/923,990

(22) Filed: Aug. 7, 2001

(51) Int. Cl. G06F 9/44

(52) U.S. Cl. 717/120; 717/123

(57) ABSTRACT

A method for documenting a plurality of source files is provided. Comment data from a current source file of the plurality of source files is accessed. Symbol data from the current source file is accessed. A document from the symbol data and the comment data in the current source file is formed. The accessing of the comment data step, the accessing of the symbol data step, and the forming of the document step is repeated for a next source file of the plurality of source files. An index based on the document files is formed.

### BACKGROUND INFORMATION

A computer program can be viewed as a detailed plan or procedure for solving a problem with a computer: an ordered sequence of computational instructions necessary to achieve such a solution. The distinction between computer programs and equipment is often made by referring to the former as software and the latter as hardware. Generally, a computer program is written in a computer language. However, in order for the computer program to operate on the hardware, it is translated into machine language that the hardware understands. Moreover, the way that different operating systems interface with different types of hardware needs to be taken into account when translating the program into machine language. An operating system is a set of programs that controls the many different operations of a computer. The operating system also directs and coordinates the computer's processing of programs.

Computers can be organized into a network, for example, a client-server network. In a client-server network, the clients and a server exchange data with one-another over a physical network. Files can be exchanged and shared between the clients and servers operating on the network.

A compiler is used to translate the computer program into machine language. It may be a task of considerable difficulty to write compilers for a given computer language, especially when the computer program is designed to operate on different types of hardware and operating systems.

Computer programs are written in a computer language, which is a formal language for writing such programs. The structure of a particular language includes both syntax (how the various symbols of the language maybe combined) and semantics (the meaning of the language constructs). Languages are classified as low level if they are close to machine code and high level if each language statement corresponds to many machine code instructions.

Compilers use a parser in the compilation process. A parser is an algorithm or program used to determine the syntactic structure of a sentence or string of symbols in some computer language. A parser normally takes as input a sequence of symbols output by a lexical analyzer. It may produce some kind of abstract syntax tree as output.

A symbol, also known as a token, is an entity that is represented by a character or key word. For example, +, −, ;, and END are symbols.

A computer program may also be compiled not into machine language, but into an intermediate language that is close enough to machine language and efficient to interpret. However, the intermediate language is not so close that it is tied to the machine language of a particular computer. It is use of this approach that provides the Java™ language with its computer-platform independence.

Computer programs are often cryptic and difficult to understand. In order to facilitate understanding, programmers document the source files that contain the written computer program. The documentation does not affect the compilation of the computer program, but instead serves to explain symbols, procedures, etc. Generally, the documentation includes written comments in a human language that explain the purpose of symbols, procedures, functions, etc.

A Javadoc program can be used to generate documentation for Java source files. In accordance with this program, after all the given source files are read by the Javadoc program, symbol information is parsed from the source files and merged with symbol information for the entire Java program. A doclet API interfaces with the Javadoc program to generate documentation via standard doclet or MIF doclet.

### SUMMARY

In accordance with a first embodiment of the present invention, a method for documenting a plurality of source files is provided. A comment from a current source file of the plurality of source files is accessed. A symbol from the current source file is accessed. A document from the symbol and the comment in the current source file is formed. The accessing a comment step, the accessing a symbol step, and the forming of the document step is repeated for a next source file of the plurality of source files. An index based on the document files is formed.

In accordance with a second embodiment of the present invention, a method for documenting source files is provided. A first comment for a first source file is accessed. A first symbol for a first source file is accessed. A first document file for the first source file is generated from the first comment and the first symbol. Subsequent to the generation of the first document file, a second comment for a second source file is accessed. A second symbol for a second source file is accessed. A second document file for the second source file is generated from the first comment and the first symbol. Subsequent to the generation of the second document file, at least one index file based on the first and second document files is generated.

In accordance with a third embodiment of the present invention, a method for documenting source files is provided. A first source file is loaded. A first comment for a first source file is accessed. A first symbol for a first source file is accessed. A first document file for the first source file is generated from the first comment and the first symbol. The first source file is unloaded. Subsequent to the unloading of the first source file, a second source file is loaded. A second comment for a second source file is accessed. A second symbol for a second source file is accessed. A second document file for the second source file is generated from the first comment and the first symbol. The second source file is unloaded. Subsequent to the unloading of the second source file, at least one index file based on the first and second document files is generated.

In accordance with a fourth embodiment of the present invention, a method for documenting source files in parallel is provided. A plurality of threads are generated. Each thread is operative on a separate processing device and each thread loads one or more, but not all, of a plurality of source files into a memory; accesses a comment from the loaded source file, and accesses a symbol from the loaded source files. Each of the plurality of threads generates a document file from the comment and the symbol and unloads the loaded source file from the memory. At least one index file is generated based on the plurality of generated document files.

### BRIEF DESCRIPTION OF THE DRAWINGS

FIG. 1 shows a prior art Javadoc program;

FIG. 2 shows a plurality of source files and a symbol service in relation to a documentation generator;

FIG. 3 shows a typical prior art source file;

FIG. 4 shows a simplified block diagram of the data flow for the documentation generator using the Sniff™ software engineering product;

FIG. 5 shows a Project Manager;

FIG. 6 shows an output window;

FIG. 7 shows a flow chart of the documentation generation cycle according an embodiment of the present invention;

FIG. 8 illustrates respective first and second documentation files in relation to respective first and second index files;

FIG. 9 shows one of the documentation files organized as a plurality of physical blocks on a memory device or a storage device; and

FIG. 10 shows the index files arranged to provide multiple levels of indexing.

### DETAILED DESCRIPTION OF THE PREFERRED EMBODIMENTS

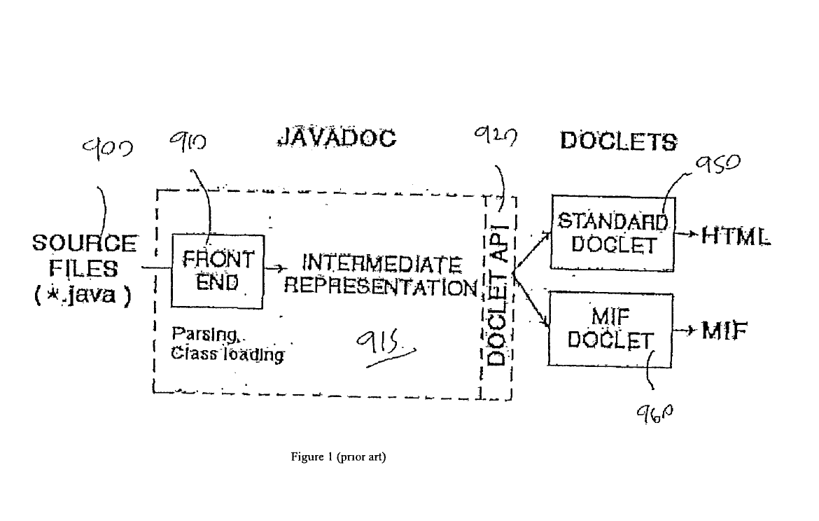

As described above, the Javadoc program automates generation of documentation files. FIG. 1 shows a prior art Javadoc program 915. A front end 910 of the Javadoc 915 reads one or more Java source files 900 . Once all the source files 900 have been read into the Javadoc 15, symbol information is parsed from the source files 910 and merged with symbol information for the entire Java program. A doclet API 920, which interfaces with the Javadoc 915, generates a standard document file 950 or a MIF document file 960 . The standard doclet 950 is in HTML format. The MIF doclet 960 is in MIF format.

The Javadoc has the disadvantage that it only works with the Java programming language. Moreover, since all the source files are read before parsing begins, large amounts of memory are required.

The documentation generator according to an embodiment of the present invention creates documentation for one or more source code files. Moreover, the documentation generator organizes the resulting documentation by use of one or more index files. First, a user selects the source code files. Then, each file is parsed for comments and symbols. A symbol service retrieves information about the symbols and merges the information with the comments. One or more documentation files are formed from the merged information. In order to locate information in the document files, one or more index files are also formed. The documentation files and index files are then stored on a storage device.

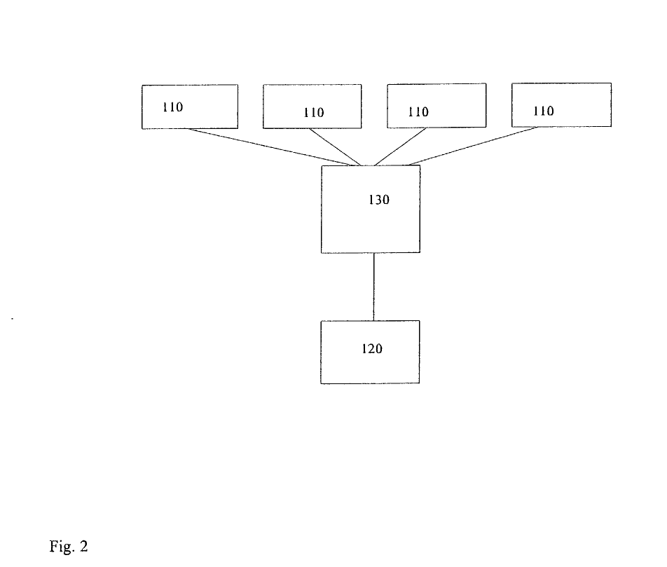

FIG. 2 shows a plurality of source files 110 and a symbol service 120 in relation to a documentation generator 30. Preferably, the source files 110 are C or C++ source files. The source files 110 can also be other programing language source files. For example, ADA, LISP, Java, or Python source files are also possible.

The symbol service 120 handles the interface between symbols, which are defined in the source code, and executing processes (e.g., the documentation generator). Preferably, the symbol service 120 is a process or thread.

The source files 110 can be located on a single device or distributed over a plurality of devices on a network. In certain embodiments, the symbol service 120 and/or documentation generator 130 can be located on the device with one or more of the source files 110. In other embodiments, the symbol service 120 and/or documentation generator 130 can be located on a device on the network without any of the source files 110. Moreover, the symbol service 120 and documentation generator 130 can be located on the same device or on separate devices.

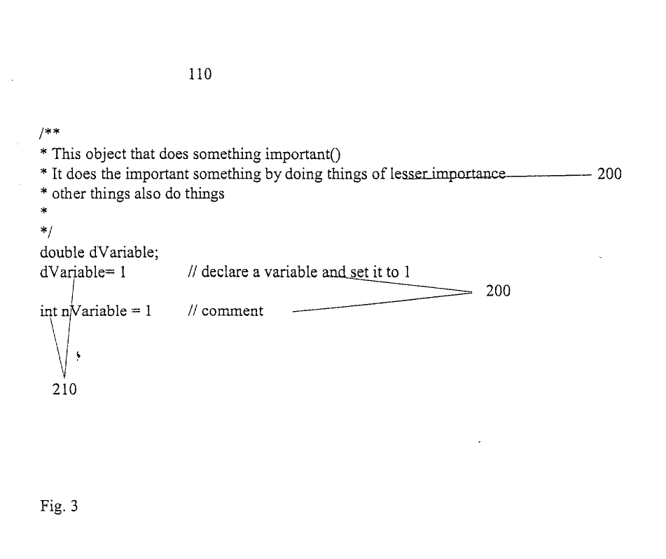

FIG. 3 shows a topical prior art source file 110. The source file contains comment information 200 along with one or more symbols 210. The symbols can be variable declarations; function or class declarations; operators; method declarations; member variable declarations; parameter declarations in methods and functions; constant definitions; or initializer blocks.

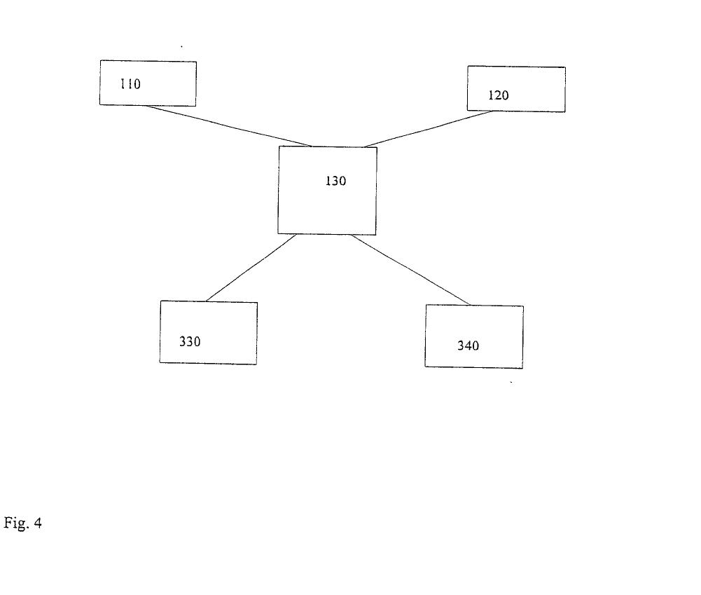

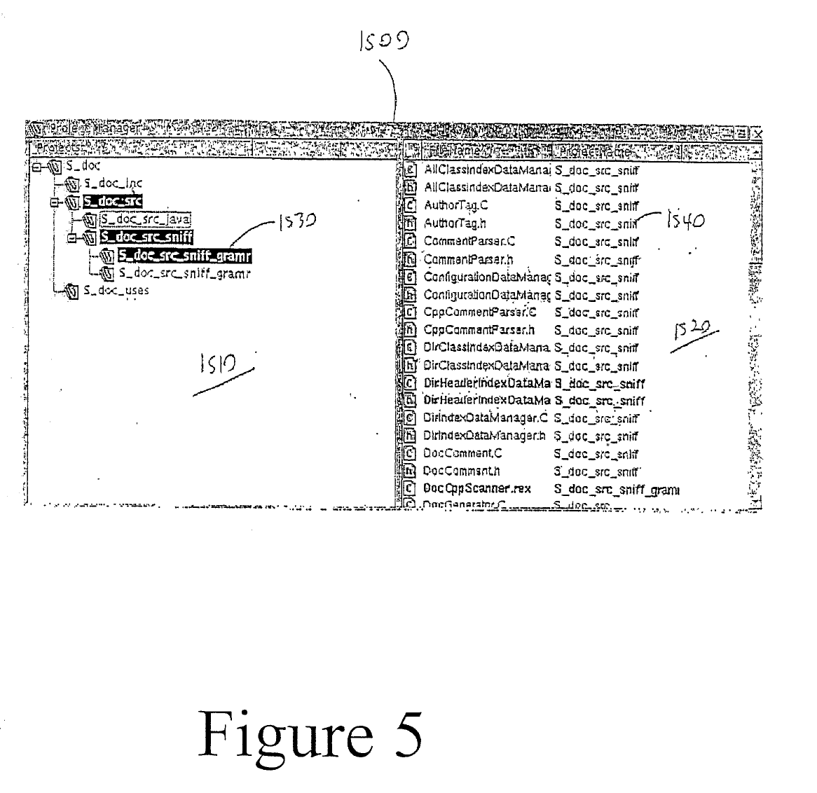

FIG. 4 shows a simplified block diagram of the data flow for the documentation generator 130 as it can be incorporated into a source code engineering tool, such as the Sniff™ source code engineering tool available from Wind River Systems, Inc. Alameda, Calif. It should be appreciated, however, that the documentation generator 130 can function with other source code engineering tools besides Sniff™ and that FIG. 4 is offered as an exemplary embodiment. For each source file 110 that is selected, comments from source files 110 are merged with information retrieved from the symbol service 120 in the documentation generator 130. Preferably, Sniff's Project Manager is used to select one or more of the source files 110 (see FIG. 5). Sniff's Project Manager is a part of the user interface for Sniff™. Most preferably, the source files 110 are C++ header files.

The comment information 200 for each source file 110 is parsed and fed into the documentation generator 130. The parsing can be done by a top-down parser or a bottom up parser. Specifically, a recursive descent algorithm; Cocke, Younger, and Kasami (CYK) algorithm; pattern matching; LL parsing; or LR parsing can be used. Specifically, the parser can be a scanner generated by Rex (a UNIX program for generating scanners). Also, for each source file 110, symbol information in the source file 110 is either parsed from the source file 110 or retrieved from the symbol service 120, such as Sniff's symbol service. The symbol information is then fed into the documentation generator 130. In certain embodiments, if comment information is lacking from the source file 110, default comment information can be fed into the documentation generator 130. In other embodiments, if comment information is lacking from the source file 110, the documentation generator 130 may generate the default comment information itself.

Preferably, if some of the source files 110 are written in Java, a Java documentation generator, such as Javadoc, can be used to generate the documentation for those source files 110. The Java documentation generator then feeds the comment information and symbol information that it generates into the documentation generator 130. Most preferably, the Java documentation generator and the documentation generator 130 are linked.

In certain embodiments, a user may define which symbols 210 to include in the documentation based on the symbol's 210 visibility (i.e., if the symbol is visible in a particular scope). Moreover, a user can select to include public symbols, private symbols, and/or protected symbols. Preferably, public is the default setting. For example, assume symbol A is defined as public in scope B and private in scope C. From scope B symbol A is visible. However, symbol A is not visible from scope C, unless the user selects to include private symbols.

In the documentation generator 130, the comment information and the symbol information are then merged. During the merging, the documentation generator 130 generates one or more index files 330, which contain index information, and one or more documentation files 340. In certain embodiments, where more than one index file 330 is generated, the index files 330 are inter-linked (e.g., the index files are organized as a doubly linked list), so that any one of the index files 330 can be used as a starting point for browsing the documentation files 340.

In certain embodiments, four types of index files 330 are generated. A class index file type (e.g., allclassindex.html) provides an alphabetical index of all documented classes and is placed in the root directory. A directory header index file type (e.g., dirheaderindex.html), which is located in a project documentation directory, provides an alphabetical index of all documented header files in the corresponding project directory. A class header index file type (e.g., classheaderindex.html) provides an alphabetical index of all documented classes in the project directory where it is located. Also placed in the root directory is an overview index file type (e.g., dirindex.html). The overview index file type provides an overview of the documented directories and has links to directory header index file types and class index header file types. Preferably, the user selects the root directory with Sniff's Project Manager.

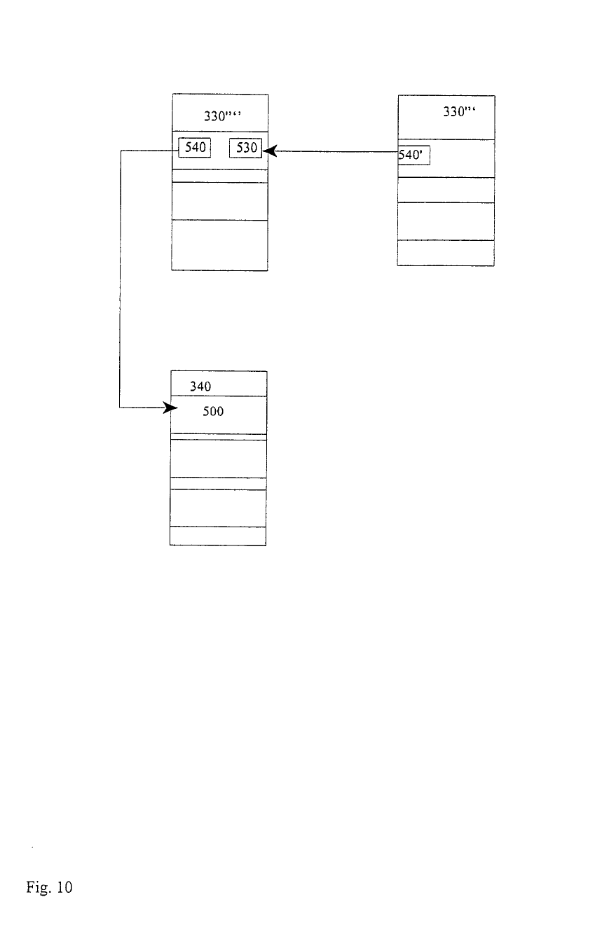

As described in more detail below with regard to FIG. 10, in certain embodiments, the index files 330 can be organized to provide multiple levels of indexing.

The documentation files 340 include internal links from the summaries to the detailed descriptions of variables, methods, and enumerations in the document. The links in the detailed descriptions may include links to the full comment for a particular variable. In certain embodiments, the alphabetic order of the symbols in the summaries can be listed. Preferably, a user can select whether or not to include an author, version, and/or title in the documentation file.

Preferably, two types of documentation files 340 are generated: a header documentation file type and a class documentation file type. The header documentation file type lists all the classes defined in the header. Also listed in the header documentation file type are all the enumerators, variables, and functions declared outside of any classes in the header documentation file (e.g., global variable).

The class documentation file type is generated for each class defined in the header. The class documentation file includes symbol declarations with the corresponding comment text from the source file for class constants; member variables; class enumerations; constructors; destructors; methods; and operators. In certain embodiments, superclass and subclass documentation files are also generated. The superclass documentation files contain the documentation for a base class, and the subclass documentation files contain the documentation for classes derived from the base class.

Preferably, the class documentation files include links back to the header documentation files. Moreover, links between superclass and subclass documentation files can be included.

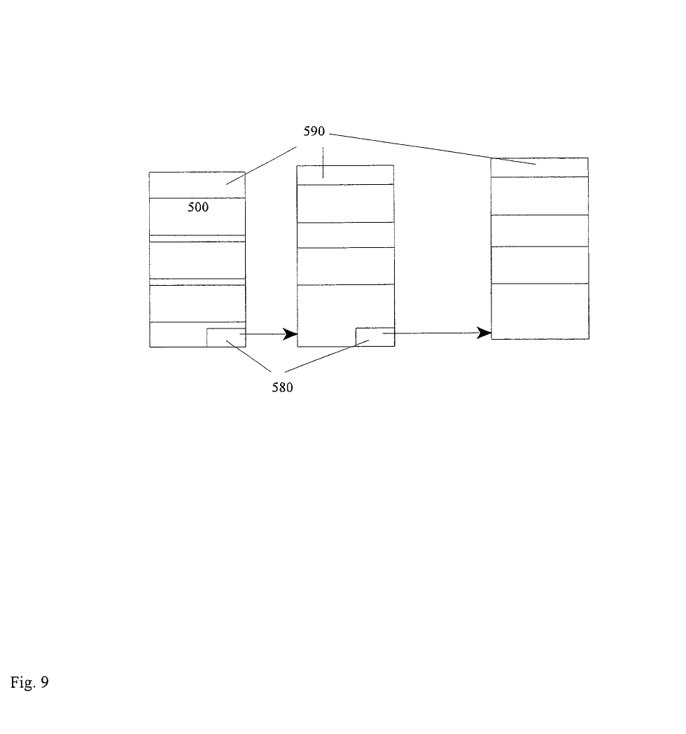

As described in more detail below with regard to FIG. 9, in certain embodiments, the documentation files 340 can be arranged as a plurality of physical blocks, as opposed to a single file.

Preferably, the documentation files 340 and/or index files 330 are in HTML format. Most preferably, HTML templates are used to generate the documentation. For example, an allclassindextemplate.html can be used to generate an HTML file for classes defined in the source files, and a dirindextemplate.html can be used to generate an HTML file for directories defined in the source files.

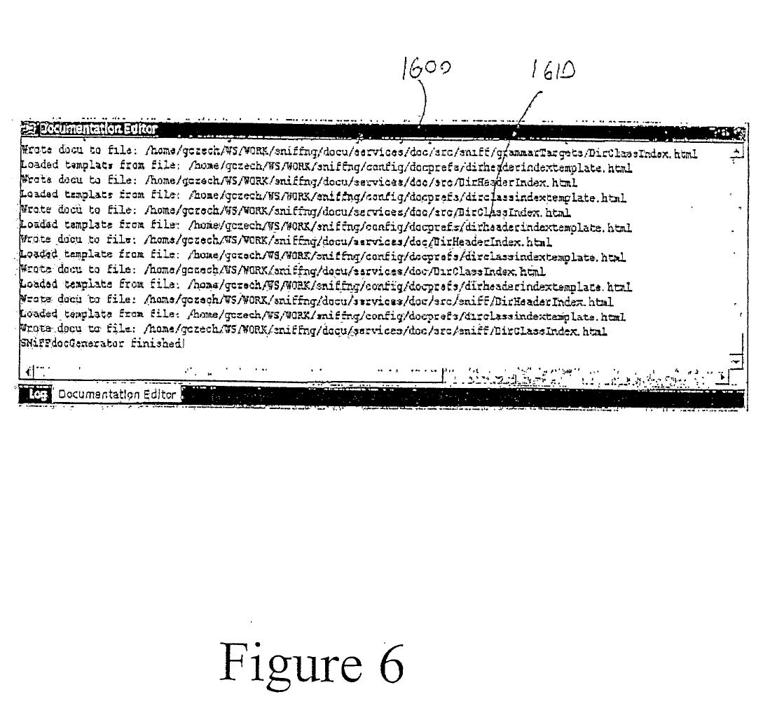

In certain embodiments, the documentation generator 130 can be configured to generate a log, which displays the output of the documentation generation process, as shown in FIG. 6.

Preferably, the index files 330 and the documentation files 340 can be arranged pursuant to an overall scheme, as shown in Table 1. The overall scheme can be user defined or hard-coded into the documentation generator 130. Most preferably, the overall scheme accords with the directory structure of the project in the Sniff+ Project Manager.

TABLE 1

<Doc-RootDir> |_AllClassIndex.html (overview index of all
classes in alphabetical order)
DirIndex.html (overview structured by directory hierarchy)
<dirl>
|_DirClassIndex.html (overview of classes in this project)
DirHeaderindex.html (overview of header files in this project)
firstheaderfile.html (document file of firstheaderfile.h (types,
vars and procedures/functions, which are not declared in classes,
and a list of classes defined in this header file)
secheaderfile.html // (document file of secheaderfile.h)
...
<classes>
|_firstheader_firstclass.html (document file
of firstclass defined in firstheader.h)
firstheader_secclass.html (document file of secclass)
secheader_firstclass.html (document file of firstclass
defind in secheader.h)
...
<subdir1>
|_...(recursively the same as in <dirl>)
<classes>
...
<subsubdir1>
|_...
<subdir2>
|_
<dir2>
|_...

FIG. 5 shows a Sniff™ Project Manager 1500. It should be appreciated, however, that the documentation generator 130 can function with other source code managing tools besides the Sniff™ Project Manager 1500 and that FIG. 5 is offered as an exemplary embodiment. The Project Manger 1500 has a projects window 1510 and a file name window 1520. In the project window 1510 are one or more project directories 1530. Each project directory 1530 includes one or more project source files 1540. Depending on which project directory 1530 is selected, the project source files 1540 in the given project directory 1530 are displayed in the file name window 1520. The project source files 1540 can then be selected to be input into the documentation generator 130. Preferably, a user selects the project directories 1530 and project source files 1540.

FIG. 6 shows an output window 1600. The output window 1600 contains a documentation log 1610, which is used to track the files that are documented and the status thereof.

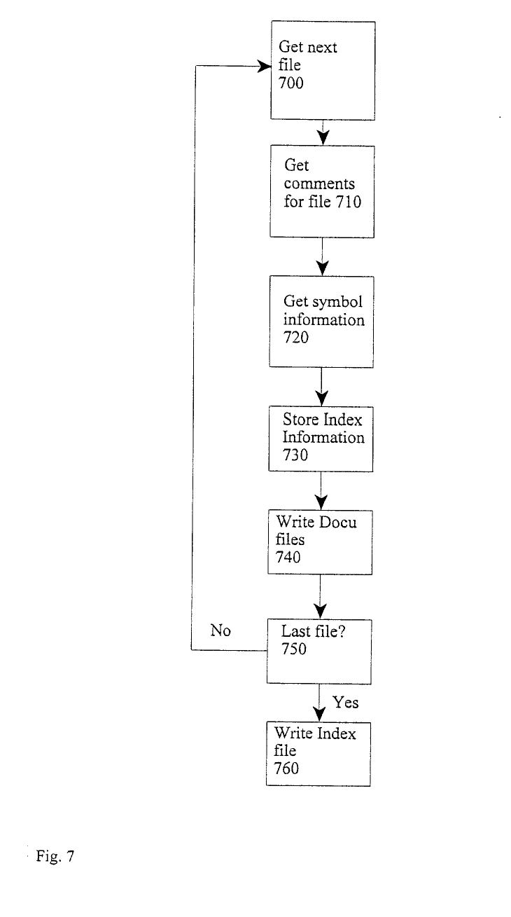

FIG. 7 shows a flow chart of the documentation generation cycle according an embodiment of the present invention. The documentation generation cycle uses a file-by-file document generation, as contrasted with the Javadoc method of loading all the source files on the same processing device at the same time. The file-by-file documentation generation allows more efficient memory usage, since not all of the files need be loaded at the same time. Moreover, in a parallel processing environment, operations can be performed on each file on separate processing devices.

In some computer languages, for example, C, C++, ADA, Pascal, and Python, language elements are used not only for object oriented programming, but also for procedural programming. Preferably, the documentation generator generates documentation for the procedural language elements (e.g., enumerations, global variables, functions, procedures, constants, type definitions, and structs) in the same way as other language elements.

First, the next source file is retrieved (Step 700). The source files can be arranged in a queue, with the next available header file at the top of the queue. A HEAD pointer may point to the first source file of the queue when the algorithm starts. Thus, when the algorithm starts, the first source file in the queue is the next available source file. In the context of the Sniff engineering tool, the source files are preferably placed in the queue by Sniff's Project Manager.

Next, the comments for the source files are retrieved (Step 710). Preferably, the comments are retrieved by parsing. The parsing can be performed using a scanner, such as a pattern-matching engine. In certain embodiments, comments can also be retrieved with other parsing methods or from some other source. For example, a database or a symbol services can also provide the comments.

The symbol information for the source file is then retrieved (Step 720). Preferably, the symbol information is retrieved from Sniff's Symbol Service.

In certain embodiments, the source file may include more than one language. Since Sniff's Symbol Service can support symbol information for multiple languages, the symbol information can be retrieved for all the symbols in the source code, regardless of the language.

In other embodiments where the source file includes a plurality of languages, multiple symbol services can be used to retrieve the symbol information. In such an embodiment, each symbol service includes symbols for separate languages. Since the languages in the source file are arranged in different blocks, the language of the block with the symbol information currently being retrieved is used to determine from which symbol service to retrieve the symbol information.

Index information is then generated and stored for the source file (Step 730). The index information may include pointers to locations within the not yet written document files (the document files are written in Step 740). In certain embodiments, the index information can be stored in a memory device as, for example, a binary tree. In other embodiments, the index information is stored in a storage device as, for example, a B-tree (a multi-way balanced tree structure).

The document file(s) 330 are then generated and written to a storage device (Step 740).

A check is made to determine whether or not the current header file is the last file (Step 750). If this is not the case, the method returns to Step 700.

If the current header file is the last file, the method writes the index information that was stored in Step 730 to an index file (Step 760). The index file 330, which allows navigation within the documentation files 340, is based on the logical structure of the programming language (e.g., object oriented analysis and classes), and on the physical structure of the source code (e.g., where the source code is located). For example, in some programming languages (e.g., Java and ADA), files or classes can be grouped into one or more packages. Moreover, files or classes in the packages can be located in the same directory or in different directories. The index file 330 can then be based on the logical concept of the packages, and thereby link all the files or classes, regardless of which directory they are located in. In certain embodiments, the directories in which the C++header files reside are considered in creating the index file 330.

In certain embodiments, the information about the physical structure can be obtained from Sniff's Project Manager (e.g., from the directory tree of the Project Manager root directory). In other embodiments, the physical structure can be generated by the documentation generator itself.

In a parallel processing embodiment, Step 700 can retrieve a plurality of the source files and send them to separate processing devices. Steps 710-740 can then be performed in parallel for each of the source files. After Step 740 completes on the separate processing device, the address of any data generated during Steps 710-740, on that particular processing device, is returned to the original processing device. Thus, the index file 330 can be generated in Step 760.

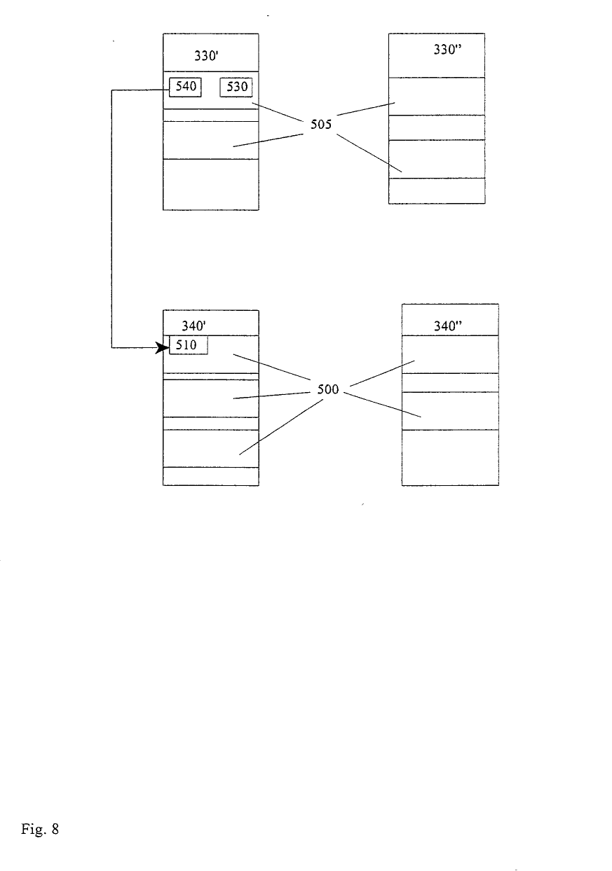

FIG. 8 illustrates respective first and second documentation files 340′, 340″ in relation to respective first and second index files 330′,330″. The documentation files 340′,340″ include a plurality of records 500. Each record further includes one or more fields 510. The fields 510 may contain information pertaining to the comments 200 or symbols 210 in the source files 110. Preferably, the records 500 are displayed to the user. The fields 510 are, preferably, encoded in HTML.

The documentation files 340′,340″ may contain different information. For example, the first documentation file 340′ may contain information about classes in a header file, while the second documentation file 340″ may have information about symbols in the header file.

The index files 330′,330″, which can be simple sequential files, contain a plurality of index records 505. Each index record 505 contains at least one pointer field 540 and an index key field 530 that interact with one-another. The data in the index key field 530 is a sequential key to find a particular record in the documentation files 340′,340″. Preferably, the index key field 530 is displayed to the user. Most preferably, the index key fields 530 are encoded in HTML. The index key fields 530 are organized pursuant to a key sequence. For example, if the key sequence is text based, the key field 530 can be a character string, or if the key sequence is numerical, the key field 530 can be an integer value. The key sequence is based on the logical structure of the programming language and the physical structure of the location of the source code. For example, a numerical key sequence can be generated by giving symbols in the programming language a certain value based on their physical location and the structure of the programming language. The pointer field 540 contains a pointer into the one or more of the documentation files 340′,340″ that references a particular record 500. In certain embodiments, the pointer may reference another index file.

The index files 330′,330″ may contain different key fields 530. For example, the first index file 330′ may contain key fields 530 for classes found in a header file, whereas the second index file 330″ may contain key fields 530 for other symbols found in the header file.

To find a particular record 500, the index files 330′,330″ are searched using the key sequence. Once the particular key is found, the user is directed by the pointer to the record 500 referenced by the pointer field 540. In certain embodiments, the user is directed to another index file (not shown) by the pointer field 540.

FIG. 9 shows one of the documentation files 330 organized as a plurality of physical blocks 590 on a memory device or a storage device. The physical blocks contain the records 500 and a block pointer 580 to the next physical block 590. The physical blocks 590 are traversed by following the block pointer 590 to the next physical block 590 when the end of a given physical block 590 is reached. Thus, the documentation file 340 remains cohesive regardless of the amount of physical blocks 590 comprising the documentation file 340. Insertion of new records 500 involves changing the pointers 580, but does not require that the new record occupy a particular position in the physical block. The physical blocks 590 are transparent to a user, i.e., regardless of the number of physical blocks 590 that form the file, from a user's perspective the documentation file 340 appears as a single entity.

FIG. 10 shows the index files a first level index file 330′″ and a second level index file 330″″ arranged to provide multiple levels of indexing. In order to provide for greater efficiency in searching, the index files 330′″,330″″ are arranged so that the pointer fields 540′ in a first level index file 330′″ reference a key field 530 in a second level index file 330″″. The pointer field 540 that interacts with the key field 530 in the second level index file 330″″ then references one of the records 500 in the document file 340.

For example, consider an index file with 1,000,000 records. A second level index file 330″″ with 1000 key fields 530 is constructed. A first level index file 330′″, of 100 entries into the second level index file 330″″, is then constructed. A search begins in the first level index file 330′″ by finding an entry point into the second level index file 330″″. The second level index file 330″″ is then searched to find an entry point into the documentation file 340. Thus, the average length of the search is reduced from 500,000 to 150 (assuming that the searched for key is in the middle of each index). In certain embodiments, more than two levels of indexing can be used.

It should be appreciated that FIGS. 8-10 are offered as exemplary embodiments and that the documentation generator can produce the documentation and index files in different formats.

In the preceding specification, the invention has been described with reference to specific exemplary embodiments thereof. It will, however, be evident that various modifications and changes may be made thereto without departing from the broader spirit and scope of the invention as set forth in the claims that follow. The specification and drawings are accordingly to be regarded in an illustrative manner rather than a restrictive sense.

What is claimed is:

1. A method for documenting a plurality of source files comprising the steps of:
(a) accessing a comment from a current source file of the plurality of source files;
(b) accessing a symbol from the current source file;
(c) forming a document file from the symbol and the comment;
(d) repeating steps a-c, wherein the current source file is a next source file of the plurality of source files; and
(e) forming an index based on the document files.

2. A method for documenting source files comprising the steps of:
accessing a first comment of a first source file;
accessing a first symbol of the first source file;
generating a first document file for the first source file from the first comment and the first symbol; and then:
accessing a second comment of a second source file;
accessing a second symbol of the second source file;
generating a second document file for the second source file from the second comment and the second symbol; and then:
generating at least one index file based on the first and second document files.

3. A method for documenting source files comprising the steps of:
loading a first source file into a memory;
accessing a first comment from the first source file;
accessing a first symbol from the first source file;
generating a first document file from the first comment and the first symbol;
unloading the first source file from the memory, and then:
loading a second source file into a memory;
accessing a second comment from the second source file;
accessing a second symbol from the second source file;
generating a second document file from the second comment and the second symbol;
unloading the second source file form the memory; and then
generating at least one index file based on the first and second document files.

4. A method for documenting a plurality of source files in parallel comprising the steps of:
generating a plurality of threads, each thread operative on a separate processing
device, and each thread further comprising the steps of:
loading one or more, but not all, of a plurality of source files into a memory;
accessing a comment from the loaded source files;
accessing a symbol from the loaded source files;
generating a document file from the comment and the symbol;
unloading the loaded source files from the memory; and
generating at least one index file based on the plurality of document files.

5. The method as recited in claim 1 wherein the source files together form a source code for an application.

6. The method as recited in claim 1 wherein the source files together form a source code for a portion of an application.

7. The method as recited in claim 1 wherein the source files together form a project.

8. The method as recited in claim 1 wherein at least one of the source files is a header file and the header file further comprises one or more classes; and wherein at least one of the documents further comprises a list of the classes.

9. The method as recited in claim 1 wherein the index comprises a plurality of pointers, each pointer referencing a location in at least one of the documents.

10. The method as recited in claim 1 wherein the index further comprises a plurality of index files, a first one of the index files further comprising a plurality of pointers, each pointer referencing a first location in a second one of the index files; and the second index file further comprising a plurality of document pointers, each document pointer referencing a document location in one of the documents.

11. The method as recited in claim 2 wherein the source files together form a source code for an application.

12. The method as recited in claim 2 wherein the source files together form a source code for a portion of an application.

13. The method as recited in claim 2 wherein the source files together form a project.

14. The method as recited in claim 2 wherein at least one of the source files is a header file and the header file further comprises one or more classes; and wherein at least one of the document files further comprises a list of the classes.

15. The method as recited in claim 2 wherein the index file comprises a plurality of pointers, each pointer referencing a location in at least one of the document files.

16. The method as recited in claim 15 further comprising the step of generating at least one index reference based on the index files, the index reference further comprising a plurality of pointers, each pointer referencing a first location in the index file.

17. The method as recited in claim 3 wherein the source files together form a source code for an application.

18. The method as recited in claim 3 wherein the source files together form a source code for a portion of an application.

19. The method as recited in claim 3 wherein the source files together form a project.

20. The method as recited in claim 3 wherein at least one of the source files is a header file and the header file further comprises one or more classes; and wherein at least one of the document files further comprises a list of the classes.

21. The method as recited in claim 3 wherein the index file comprises a plurality of pointers, each pointer referencing a location in at least one of the document files.

22. The method as recited in claim 21 further comprising the step of generating at least one index reference based on the index files, the index reference further comprising a plurality of pointers, each pointer referencing a first location in the index file.

23. A system for documenting source files comprising:
a computer processor coupled to a memory;
the computer processor accessing a first comment data for a first source file;
accessing a first symbol data for the first source file;
generating a first document file for the first source file from the first comment data and the first symbol data; and then:
accessing a second comment data for a second source file;
accessing a second symbol data for the second source file;
generating a second document file for the second source file from the second comment data and the second symbol data; and then:
generating at least one index file based on the first and second document files.

24. A method for documenting source files in parallel comprising the steps of:
loading a first source file into a memory on a first device;
accessing a first comment data from the first source file on the first device;
accessing a first symbol data from the first source file on the first device;
generating a first document file from the first comment data and the first symbol data on the first device;
unloading the first source file from the memory on the first device;
loading a second source file into a memory on a second device;
accessing a second comment data from the second source file on the second device;
accessing a second symbol data from the second source file on the second device;
generating a second document file from the second comment data and the second symbol data on the second device;
unloading the second source file form the memory on the second device; and
generating at least one index file based on the first and second document files.

25. The method as recited in claim 4 wherein the memory is distributed over a plurality of devices.

26. The method as recited in claim 1 further comprising selecting the source file from a project management interface.

27. The method as recited in claim 2 wherein the first symbol is accessed from a symbol service.

28. A system comprising:
a project management facility configured to display at least one of a plurality of source code files;
a documentation generator facility configured to receive at least one selection of the at least one of the plurality of source code files;
wherein the documentation generator facility:
(a) accesses a comment from a current source code files of the plurality of source code files;
(b) accesses a symbol from the current source code file;
(c) forms a document file from the symbol and the comment;
(d) repeats steps a-c, wherein the current source code file becomes a next source code file of the plurality of source files; and
(e) forms an index based on the document files.

29. A computer-readable medium, having stored thereon, computer executable process steps operative to control a computer to documenting source files, the steps comprising:
(a) accessing a comment from a current source file of the plurality of source files;
(b) accessing a symbol from the current source file;
(c) forming a document file from the symbol and the comment;
(d) repeating steps a-c, wherein the current source file becomes a next source file of the plurality of source files; and
(e) forming an index based on the document files.

30. A computer-readable medium, having stored thereon, computer executable process steps operative to control a computer to document source files, the steps comprising:
accessing a first comment of a first source file;
accessing a first symbol of the first source file;
generating a first document file for the first source file from the first comment and the first symbol; and then:
accessing a second comment of a second source file;
accessing a second symbol of the second source file;
generating a second document file for the second source file from the second comment and the second symbol; and then:
generating at least one index file based on the first and second document files.

31. A computer-readable medium, having stored thereon, computer executable process steps operative to control a computer to document source files, the steps comprising:
loading a first source file into a memory;
accessing a first comment from the first source file;
accessing a first symbol from the first source file;
generating a first document file from the first comment and the first symbol;
unloading the first source file from the memory, and then:
loading a second source file into a memory;
accessing a second comment from the second source file;
accessing a second symbol from the second source file;
generating a second document file from the second comment and the second symbol;
unloading the second source file form the memory; and then
generating at least one index file based on the first and second document files.

32. A computer-readable medium, having stored thereon, computer executable process steps operative to control a computer to document source files, the steps comprising:
generating a plurality of threads, each thread operative on a separate processing device, and each thread further comprising the steps of:
loading one or more, but not all, of a plurality of source files into a memory;
accessing a comment from the loaded source files;
accessing a symbol from the loaded source files;
generating a document file from the comment and the symbol;
unloading the loaded source files from the memory; and generating at least one index file based on the plurality of document files.
